(19) United States
(12) Patent Application Publication
(10) Pub. No.: US 2019/0007769 A1
(43) Pub. Date: Jan. 3, 2019

(54) Microphone Structure for Cell Phone Real-Time Voice Translation in Traveling

(71) Applicant: Shao-Chieh Ting, New Taipei City (TW)

(72) Inventors: Shao-Chieh Ting, New Taipei City (TW); Chun-Hsin Ting, New Taipei City (TW)

(21) Appl. No.: 15/860,650

(22) Filed: Jan. 2, 2018

(30) Foreign Application Priority Data
Jun. 30, 2017 (TW) 106121993
Oct. 13, 2017 (TW) 106215128

(51) Int. Cl. H04R 1/40; H04R 1/08; H04R 1/02; H04R 1/04

(52) U.S. Cl. CPC H04R 1/406; H04R 1/086; G06F 17/2836; H04R 1/04; H04R 1/028

(57) ABSTRACT

A microphone structure for cell phone real-time voice translation in traveling includes primarily a set of microphone screens, a hollow tube, a transmission line, an electret condenser PCB assembly, a set of PCB assembly covers (front and rear), and a plug. Upon being used with voice translation software, the microphone structure is used by inserting into a cell phone charging jack and turning off a microphone on the cell phone. The disclosed structure can utilize two unidirectional microphones or one bidirectional microphone, with a transmission line being added between the microphone and the plug, so as to maintain a clear sound quality for a cell phone owner and a dialogue person within a social distance zone, thereby enabling the voice translation to be accurate and smooth.

### FIELD OF THE INVENTION

The present invention relates to a microphone structure which is directly used in cell phone real-time voice translation, and more particularly to a microphone structure that is used by inserting into a cell phone charging jack and turning off a microphone on the cell phone.

### BACKGROUND

As the rapid development in smart phones and their application software, inventors have realized the market prospects and the potential of creation for mobile equipment, such as cell phones; whereas, an external microphone for a cell phone is one of many peripheral products that have emerged.

Most of the conventional cell phone microphones are provided with a microphone head of a unidirectional microphone along one direction. This unidirectional microphone is either too large or is produced and assembled tediously. When the microphone using the unidirectional microphone head is applied to the real-time voice translation of the present invention, the direction of the microphone should be adjusted to align with the person whose voice is to be recorded, so as to achieve a better effect of voice translation. In addition, the distance between the cell phone owner and the dialogue person cannot be too far; otherwise, the ambient noises can be picked up easily to affect the quality of voice translation. However, if the distance between the two talking parties is too close, it will be impolite. Besides that, in using the microphone, the microphone that is too large will shield part of an earphone hole or speaker hole on the cell phone, thereby affecting the normal use of the microphone. Even if the earphone is inserted into ears of the other party, it can result in bacterial infection easily as many people have used the earphone, which is not perfect either.

Accordingly, the abovementioned conventional external microphone for the cell phone is still provided with the shortcomings and is indeed not a good design; therefore, the improvement is required.

### SUMMARY OF THE INVENTION

An object of the disclosed device is to provide a microphone structure for cell phone real-time voice translation in traveling, including a set of microphone screens, a hollow tube, a transmission line, an electret condenser PCB (Printed Circuit Board) assembly, a set of PCB assembly covers (front and rear) and a plug.

Another object is to provide a microphone structure for cell phone real-time voice translation in traveling, wherein two unidirectional microphones or one bidirectional microphone is used, and the transmission line is added between the microphone and a plug, which maintains a clear sound quality for a cell phone owner and a dialogue person within a social distance zone, so that the voice translation can be accurate and smooth.

To enable a further understanding of the said objectives, the features and the advantages herein, the brief description of the drawings below is followed by the detailed description of embodiments.

### BRIEF DESCRIPTION OF THE DRAWINGS

FIG. 1 shows a three-dimensional schematic view of an electret condenser microphone for cell phone real-time voice translation in traveling.

FIG. 2 shows a three-dimensional exploded view of the electret condenser microphone for cell phone real-time voice translation in traveling.

FIG. 3 shows a three-dimensional schematic view of inserting the electret condenser microphone for cell phone real-time voice translation in traveling, into a cell phone for use, according to the present invention.

FIG. 4 shows a three-dimensional schematic view of an embodiment of sheathing the electret condenser microphone for cell phone real-time voice translation in traveling, into a clothes peg for use.

FIG. 5 shows a circuit diagram of a microphone structure for cell phone real-time voice translation in traveling, outputting an analog signal.

FIG. 6 shows a circuit diagram of the microphone structure for cell phone real-time voice translation in traveling, outputting a digital signal.

FIG. 7 shows a schematic view of a circuit design for the electret condenser microphone for cell phone real-time voice translation in traveling, wherein a bidirectional microphone is used.

FIG. 8 shows another schematic view of the circuit design for the electret condenser microphone for cell phone real-time voice translation in traveling, wherein the bidirectional microphone is used.

### DETAILED DESCRIPTION OF THE EMBODIMENTS

The disclosed device utilizes, in some embodiments, two unidirectional microphones or one bidirectional microphone, with a transmission line being added between the microphone and a plug, so as to maintain a clear sound quality for a cell phone owner and a dialogue person within a social distance zone, thereby enabling the voice translation to be accurate and smooth.

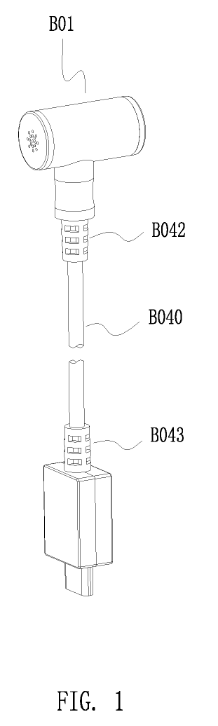

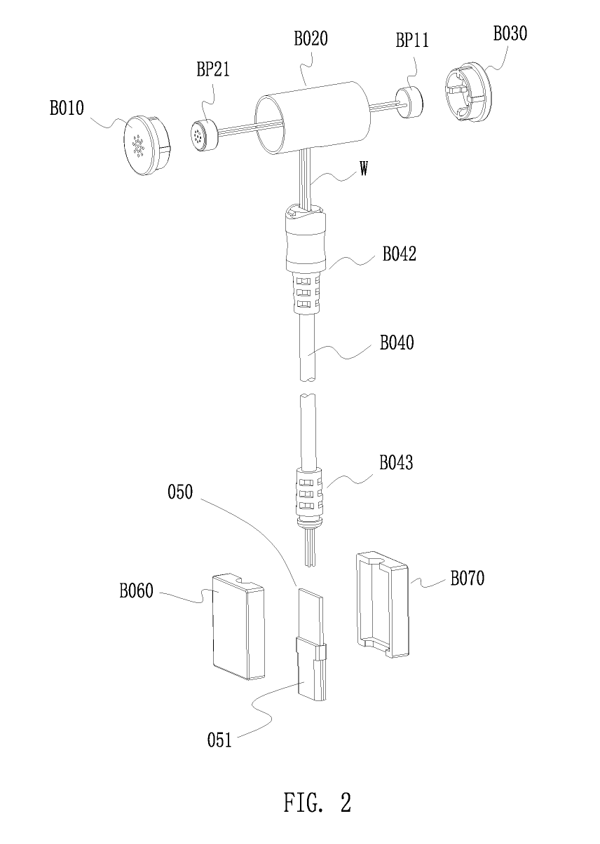

Referring to FIG. 1 to FIG. 2, it shows a three-dimensional schematic view and a three-dimensional exploded view of an electret condenser microphone B01 for cell phone real-time voice translation in traveling, comprising primarily a front microphone screen B10, a first unidirectional microphone BP21, a hollow tube B020, a rear microphone screen B030, a second unidirectional microphone BP11, a transmission line B040, an electret condenser PCB assembly 050, a front PCB assembly cover B060 and a rear PCB assembly cover B070.

The front microphone screen B010 is used to sheath the first unidirectional microphone BP21 and is tightly fixed on an end of the hollow tube B020.

The hollow tube B020 encloses the front microphone screen B010 and the rear microphone screen B030, and is connected with the transmission line B040.

The rear microphone screen B030 is used to sheath the second unidirectional microphone BP11 and is tightly fixed on the other end of the hollow tube B020.

Furthermore, the abovementioned front microphone or rear microphone can be used, and is replaced by a bidirectional microphone.

The transmission line B040 is used to connect an upper-end microphone assembly (the hollow tube B020) and a lower-end plug assembly (the plug 051), increasing the clearness in sound quality of conversation between two parties (a cell phone owner and a dialogue person) and the noise isolation effect. Two ends of the transmission line B040 are provided respectively with a strain relief (SR) B042, B043, and an internal core wire W is used to weld the first unidirectional microphone BP11, the second unidirectional microphone BP21 and the electret condenser PCB assembly 050.

The electret condenser PCB assembly 050 is provided with the plug 051.

The front PCB assembly cover B060 and the rear PCB assembly cover B070 are used to cover the electret condenser PCB assembly 050.

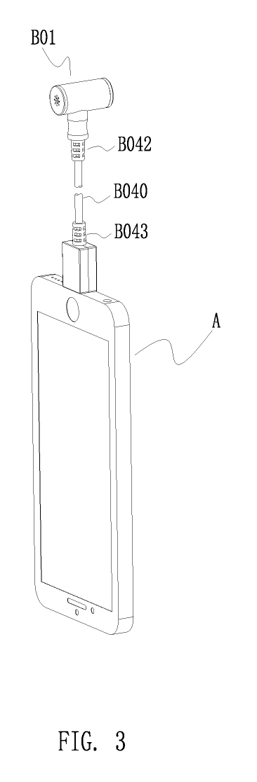

Referring to FIG. 3, it shows a three-dimensional schematic view of inserting the electret condenser microphone for cell phone real-time voice translation in traveling, into a cell phone A for use.

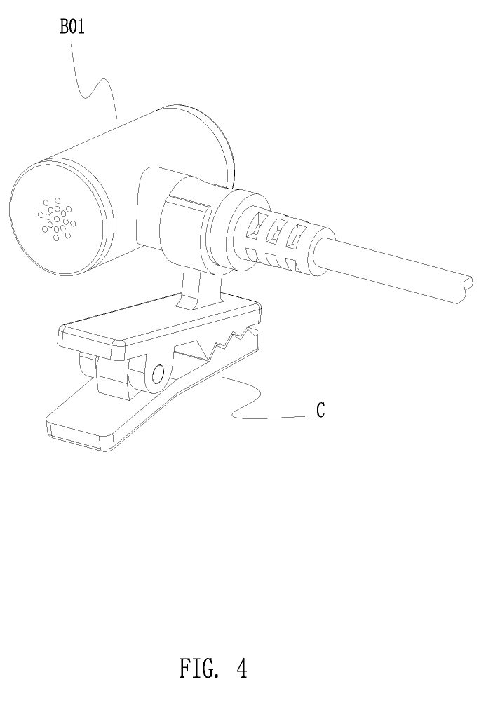

Referring to FIG. 4, it shows a three-dimensional schematic view of an embodiment of sheathing the electret condenser microphone for cell phone real-time voice translation in traveling, into a clothes peg C for use. This product is suitable for use in interview.

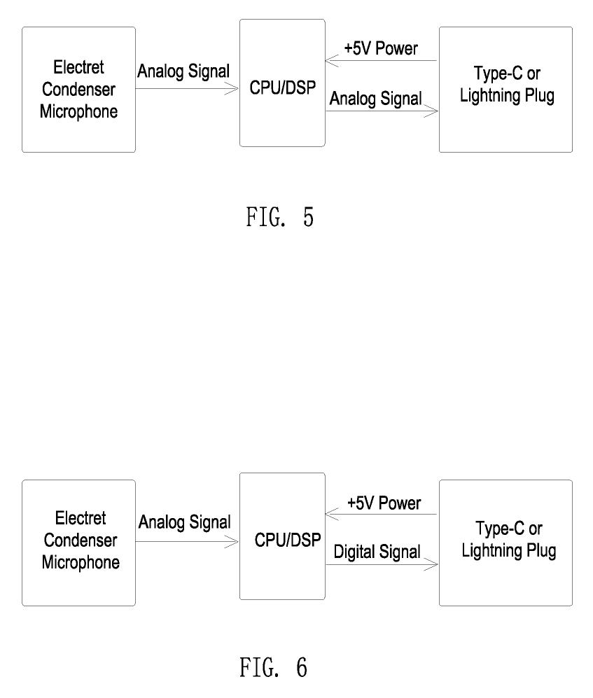

Referring to FIG. 5 and FIG. 6, it shows circuit diagrams of a microphone structure for cell phone real-time voice translation in traveling. In some embodiments, the structure is constituted by an electret condenser microphone, CPU (Central Processing Unit)/DSP (Digital Signal Processor), and a Type-C or Lightning plug. Microphone signals are converted into digital signals by ADC (Analog-to-Digital Converter) and fed into CPU, whereas CPU is provided with DSP to remove the ambient noises in the signals, thereby obtaining a high-quality signal output. These output signals can be analog or digital, depending upon the cell phone specifically.

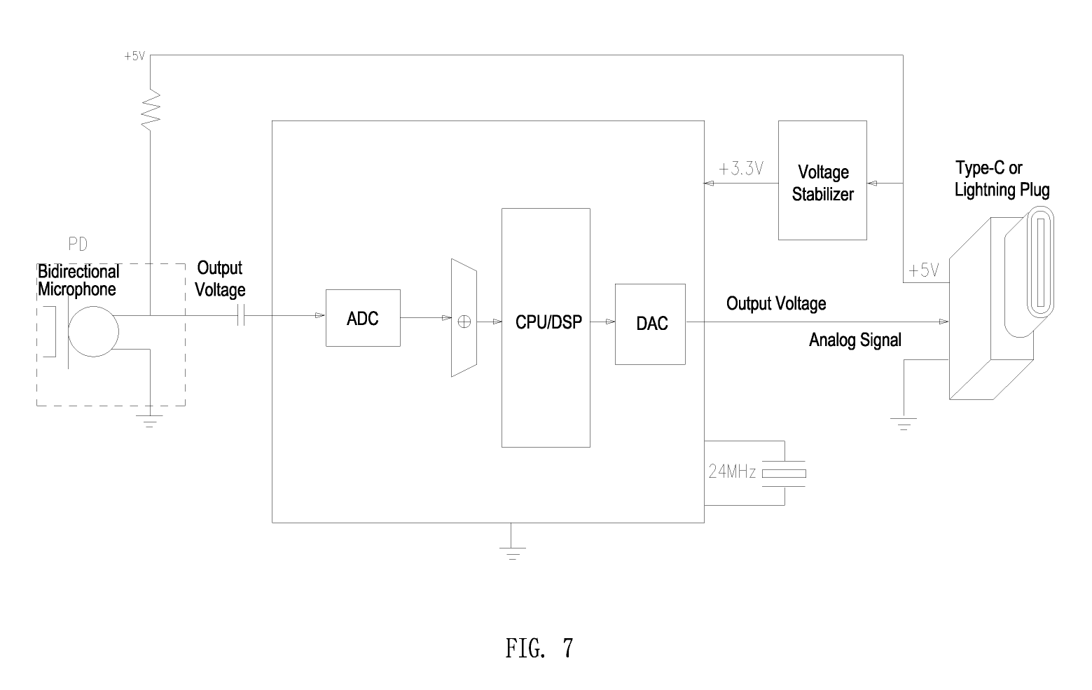

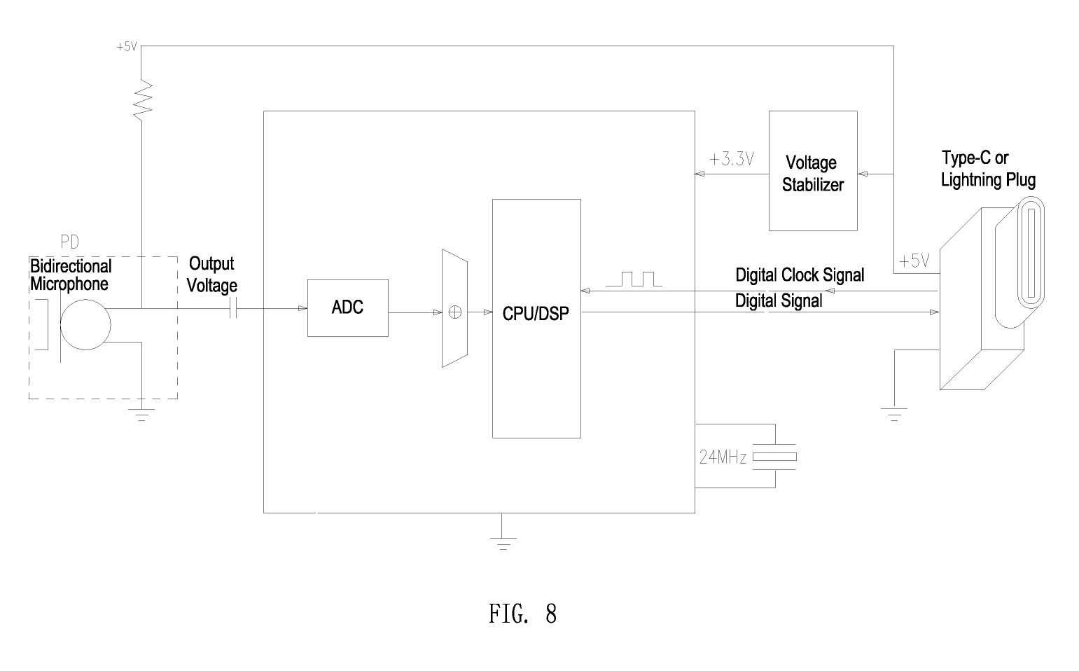

Referring to FIG. 7 and FIG. 8, it shows schematic views of a circuit design for the electret condenser microphone for cell phone real-time voice translation in traveling, wherein a bidirectional microphone is used. This product is formed by a bidirectional microphone PD, CPU/DSP and a Type-C or Lightning plug.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A microphone structure for cell phone real-time voice translation in traveling, comprising:
a set of first unidirectional microphone, front microphone screen, second unidirectional microphone and rear microphone screen which are disposed respectively on each end of a hollow tube;
the hollow tube further comprising an annular surface having a hole for transfixing with a microphone head and a PCB (Printed Circuit Board) assembly connection wire; and
an electret condenser PCB assembly, which is provided with a plug and is affixed to a front PCB assembly cover and a rear PCB assembly cover;
wherein the first and second unidirectional microphones are a bidirectional microphone.

2. The microphone structure for cell phone real-time voice translation in traveling, according to claim 1, wherein a transmission line is disposed between an upper-end microphone assembly and a lower-end plug assembly.

3. The microphone structure for cell phone real-time voice translation in traveling, according to claim 1, wherein the microphone is sheathed into a fitted clothes peg.
